(19) United States
(12) Patent Application Publication
(10) Pub. No.: US 2025/0051609 A1
(43) Pub. Date: Feb. 13, 2025

(54) USE OF AND METHOD FOR PREPARING POLYIMIDE AEROGELS

(71) Applicants: EMPA EIDGENOSSISCHE MATERIALPRUFUNGS-UND FORSCHUNGSANSTALT, Dubendorf (CH); IBIH ADVANCED MATERIAL CO., LTD., Hebei (CN)

(72) Inventors: Tingting WU, Dübendorf (CH); Joshua YIP, Coedkernew Casnewydd (GB); Shanyu ZHAO, Dübendorf (CH); Wim MALFAIT, Zürich (CH); Qin LI, Shaanxi (CN); Yunhong WANG, Beijing (CN)

(21) Appl. No.: 18/719,154

(22) PCT Filed: Dec. 12, 2022
(86) PCT No.: PCT/EP2022/085397

§ 371 Date: Jun. 12, 2024

(30) Foreign Application Priority Data
Dec. 13, 2021 (EP) 21213960.4

(51) Int. Cl. C09D 179/08; C08G 73/10; C08J 9/28; H01B 3/30

(52) U.S. Cl. CPC C09D 179/08; C08G 73/1014; C08G 73/1032; C08G 73/1042; C08G 73/1071; C08J 9/286; H01B 3/306; C08J 2201/0502; C08J 2203/08; C08J 2205/026; C08J 2205/042; C08J 2205/044; C08J 2379/08

(57) ABSTRACT

The present invention pertains to the use of a polyimide aerogel, wherein the polyimide aerogel comprises polyimide spheres having a diameter of 250 nm to 20 μm, as an insulating, sorption or filter material, as well as to methods for the preparation of the same.

The present invention pertains to the use of a polyimide aerogel, wherein the polyimide aerogel comprises polyimide spheres having a diameter of 250 nm to 20 μm, as an insulating, sorption or filter material, as well as to methods for the preparation of the same.

### BACKGROUND

Polyimides are high-performance engineering polymers with inherent attributes of good mechanical property, low permittivity and excellent chemical stability when exposed to high temperature or harsh chemical environments. Polyimide aerogels are porous materials with the intrinsic chemical composition and properties of polyimide materials, generally prepared by the sol-gel process, followed by supercritical CO₂ drying. However, due to their unique mesoporous ‘aerogel’ structures, the final physical properties of the obtained polyimide aerogels, such as porosity, density, thermal conductivity, dielectric constant, as well as shrinkage during drying and application, strongly depend on the selections of the initial monomers and the use of cross-linkers. Even though the chemical cross-linking and monomer selection can, to some extent, reduce the shrinkage of the polyimide aerogels during the synthesis, gelation, and drying, there is still a common problem for the polyimide aerogels: large volumetric shrinkage when exposed to high temperatures (for example around 26% linear shrinkage at 150° C. for 24 h and 40% linear shrinkage at 200° C. for 24 h), resulting in little utilization for high temperature applications. Typically, the shrinkage of the polyimide aerogels has been addressed by crosslinking of the polyimide, by adding suitable fillers or by introducing specific monomers. For example, Silica/silanes have been introduced to form more rigid networks, e.g. 3-aminopropyltrimethoxysilane (APTES), bis(trimethoxysilylpropyl)amine (BTMSPA) and octa(aminophenyl)-silsesquioxane (OAPS). Furthermore, inorganic silica or silica aerogel fillers have been reported to stabilize the PI aerogels (M. A. B. Meador et al., Polymer Preprints 51 (2010) 265; S. Wu et al., RSC Adv. 6 (2016) 58268-58278). After adding the silica or silica aerogel fillers, the shrinkage during the synthesis could be improved, but due to the high viscosity of the polyamic acid solution, the mixture with the silica particles required vigorous stirring for a long period of time, which process firstly over-breaks the silica aerogel particles and downgrades the aerogel properties, and secondly promotes the penetration of the oligomers/polymers into the silica aerogel pores, which ultimately leads to a densification of the composites.

It is the objective of the present invention to provide improved polyimide materials, as well as new uses for polyimide materials.

In a first aspect, the present invention is directed to a use of a polyimide aerogel, wherein the polyimide aerogel comprises or optionally consists of polyimide spheres having a diameter of 250 nm to 20 μm, optionally 1 μm to 10 μm as an insulating, sorption or filter material or as low dielectric constant material for electronics, optionally at high temperatures.

It was surprisingly found that the polyimide aerogel described herein is stronger to resist the deformation during thermal treatment compared to prior art materials. Furthermore, the material described herein extends the drying possibilities of the polyimide gels from supercritical drying to oven drying (ambient pressure drying). It was further surprisingly found that the polyimide aerogel described herein has excellent utility as an insulating, sorption or filter material or as low dielectric material for electronics, optionally at high temperatures.

The term “polyimide spheres” as used herein refers to essentially spherical polyimide nanofiber structures. The spheres are not necessarily completely round and they may be in a “budded” form, i.e. two spheres may be connected together and are still considered spheres within the context of this invention.

The polyimide spheres of the material described herein are made of polyimide nanofiber strands. The nanofiber strands are organized in networks, which in turn form the spheres. These networks may be dense or loose, i.e. the networks themselves may be porous (loose) or comprise essentially no pores (dense). The polyimide aerogel described herein itself comprises pores which are essentially the spaces between the spheres, whereas the spheres themselves may also be porous or not, wherein the pores of the spheres are those formed by the nanofiber network making up the spheres.

The terms “pores” or “porous”, as used herein, mean that pores are present to the extent that these are detectable, e.g. by standard optical methods such as scanning electron microscopy.

Whenever a range is defined as being between two numerical values, this range includes the indicated numerical values.

The term “low dielectric constant materials” is commonly understood in the art. For example, low dielectric constant materials are those with a dielectric constant of less than about 3.9. Examples for low dielectric constant materials for electronics include, e.g., silicon-based dielectrics (SiO₂), polyimide films, and polyimide aerogels.

In an embodiment, the polyimide aerogel described herein is silicon-free, and/or comprises no inorganic mesoporous material, optionally no silica aerogel.

In an embodiment, the use of the present invention is one, wherein the polyimide spheres are porous, optionally having pores with diameters between 1 nm to 100 nm, optionally 2 nm to 100 nm.

In an embodiment, the use of the present invention is one, wherein the pores between polyimide spheres range from 0.2 μm to 500 μm, optionally from 1 μm to 200 μm.

As noted above, the polyimide aerogel described herein itself comprises pores and these pores are the pores/spaces between the polyimide spheres.

All pores and spaces can be measured, e.g. by SEM, and the numerical ranges refer to the diameter of the pores. If the pores are not round, then the numerical ranges refer to the largest distance between polyimide spheres or between nanofiber strands.

In an embodiment, the use of the present invention is one, wherein the polyimide aerogel is used as a thermal or electrical insulating material, optionally in electronic devices, robotics, aviation, astronautics, refrigeration, industrial installations, and pipelines, or in low dielectric constant materials, optionally for antennas.

In an embodiment, the use of the present invention is one, wherein the polyimide aerogel is halogen-free, optionally fluorine-free, optionally does not comprise or is not made from 2,2,-bis(3,4-dicarboxyphenyl)hexafluoropropane dianhydride (6FDA) or 9,9-bis(4-aminophenyl)-fluorene (BAPF).

In an embodiment, the use of the present invention is one, wherein the polyimide aerogel has a thermal conductivity measured at 25° C. and 50% relative humidity of less than about 40 mW/(m*K), optionally less than about 35 mW/(m*K).

The thermal conductivity of the polyimide aerogel of the present invention can be measured by known methods providing essentially the same results. These methods include, e.g., guarded hot plate, transient hot wire, heat-flow meter, or laser flash diffusivity, where the guarded hot plate is the preferred method.

The polyimide aerogel described herein and for use herein optionally has a low volumetric shrinkage of 0 to 20%, optionally from 5 to 12%, while kept up to 350° C. for 1 hour. Afterwards, the thermal conductivity measured at 25° C. and 50% relative humidity of shrunk polyimide aerogel is less than 40 mW/(m*K), preferably less than 36 mW/(m*K). Also, the spherical structure in polyimide aerogel can resist degradation up to 350° C. Without wishing to be bound by theory, these properties are assumed to be the result of the material composition described herein, e.g. that the polyimide aerogel comprises polyimide spheres having a diameter of 250 nm to 20 μm.

In an embodiment, the use of the present invention is one, wherein the polyimide aerogel is hydrophobic and optionally the water contact angles on the polyimide aerogel are between 90° and 140°, optionally between 100° to 130°. Optionally, the polyimide aerogel has a low wettable surface by water.

Without wishing to be bound by theory, it is believed that the hydrophobic nature of the polyimide aerogel is attributed to the spherical structure.

In an embodiment, the use of the present invention is one, wherein the polyimide aerogel has
a. a density of 0.06 to 0.2 g/cm³, optionally 0.10 to 0.17 g/cm³;
b. a porosity of 80 to 98%, optionally of 85 to 94;
c. a Brunauer-Emmett-Teller specific surface area of 1 to 350 m²/g, optionally 10 to 100 m²/g; and/or
d. a Young's Modulus of 0.2 to 5 MPa, optionally 0.5 to 2.0 MPa.

The following standard methods can be used to determine (a) the density: calculate from the equation (mass/volume); (b) the porosity: calculate from the equation (1−(bulk density/skeletal density)); (c) the Brunauer-Emmett-Teller specific surface area: BET nitrogen adsorption-desorption test; and (d) the Young's Modulus: the slope of initial linear part of the strain-stress curve from compression test.

In an embodiment, the use of the present invention is one, wherein the polyimide aerogel is cross-linked and optionally has a degree of crosslinking of 1 to 100%, optionally 50-100%.

In an embodiment, the polyimide aerogel described herein is not cross-linked and optionally has a degree of crosslinking of 0%.

The polyimide, as used herein and for the use described herein, refers to any polyimide that is chemically stable. For example, any commercially available polyamine and diamine, and polyanhydride and dianhydride, can be used to form the polyimide described herein. For example, aromatic diamines and/or polyamines and dianhydrides can be used. Alternatively, aliphatic diamines and dianhydrides can be used. If used, the crosslinkers can be based on aromatic or aliphatic scaffolds.

In an embodiment, the use of the present invention is one, wherein the polyimide aerogel comprises
(a) diamine monomers selected from the group consisting of 4,4′-diaminodiphenyl ether (ODA); 2,2′-dimethylbenzidine (DMBZ); 9,9-bis(4-aminophenyl)fluorene (BAPF); 2-bis [4-(4-aminophenoxy) phenyl]propane (BAPP); p-phenylene diamine (PPDA); and 4,4′-diaminodiphenylmethane (MDA) and combinations thereof;
(b) dianhydride monomers selected from the group consisting of 3,3′,4,4′-biphenyltetracarboxylic dianhydride (BPDA); 4,4′-diphenyl ether dianhydride (ODPA); pyromellitic dianhydride (PMDA); 3,3′,4,4′-benzophenonetetracarboxylic dianhydride (BTDA); and combinations thereof; optionally BPDA and PMDA; and/or
(c) crosslinkers selected from the group consisting of 1,3,5-benzenetricarbonyl trichloride (BTC); tris(2-aminoethyl)amine (TREN); 1,3,5-tris(4-aminophenoxy)benzene (TAB); polymaleic anhydride (PMA); tris(4-aminophenyl amine) (TAPA); and triisocyanate; optionally BTC and TREN,
   wherein, optionally, the molar ratio of diamine to dianhydride monomers within the polyimide is n:(n+1) or (n+1):n, wherein n is an integer ≥5, optionally 5 to 40.

Optionally, the polyimide aerogel does not comprise 9,9-bis(4-aminophenyl)fluorene (BAPF).

Optionally, the molar ratio of diamine to dianhydride monomers within the polyimide is n:(n+1) or (n+1):n, wherein n is an integer ≥5, optionally 5 to 40. For example, in the case of 6:5, a diamine to dianhydride ratio of 6:5 corresponds to polyamic acid with on average 6 diamine units and 5 dianhydride units. A diamine to dianhydride ratio of 1:1 corresponds to an infinite polyamic acid chain.

Optionally, the average length of the polyamic acid before crosslinking described herein is from 2,500 to 50,000 (molar mass g/mol).

All diamine and dianhydride monomers disclosed herein refer to the monomers that are present in the polymer, i.e. result in the polymer. In other words, the above describes that the polyimide polymer comprises one or more the above-listed monomers in their subsequent polymeric form.

All definitions, explanations and features described herein with reference to the use of the polyimide aerogel also apply to a polyimide aerogel as such, and to a method for preparing the polyimide aerogel, e.g. to methods disclosed herein.

In another aspect, the present invention is directed to a method for preparing the polyimide aerogel as described herein, comprising the following steps:
(i) providing a polyamic acid, optionally by mixing diamine monomers and dianhydride monomers, in an aprotic solvent comprising or consisting of a solvent selected from the group consisting of dimethylacetamide (DMAc), dimethylformamide (DMF), dimethyl sulfoxide (DMSO), mixtures thereof and mixtures of N-methyl-2-pyrrolidone (NMP) with at least one of DMAc, DMF and/or DMSO;
(ii) adding acetic anhydride and triethylamine to the polyamic acid of (i) to form a polyimide sol and to induce phase separation of the polyimide from the aprotic solvent, optionally at room temperature;
(iii) optionally adding a crosslinker before gelation of the polyimide sol, optionally BTC or TREN, to form a crosslinked polyimide sol,
(iv) optionally aging the gelled polyimide sol of steps (ii) and/or (iii); and
(v) drying the mixture of step (iv).

In step (i) of the method described herein, the diamine monomers and dianhydride monomers are optionally mixed in a molar ratio of diamine to dianhydride monomer of n:(n+1) or (n+1):n, n≥5, as described above in the context of the polyimide aerogel and its use. For example, a diamine to dianhydride ratio of 6:5 corresponds to polyamic acid with an average 6 diamine units and 5 dianhydride units. A diamine to dianhydride ratio of 1:1 theoretically corresponds to an infinite polyamic acid chain. Concentration of the polyamic acid can, for example, be set to about 3 to 30 or about 5 to 15 wt. % and the mixing time (e.g. with agitating or stirring) can be set to about 1 to 60 minutes, optionally about 5 to 60 or 15 to 40 minutes or about 30 minutes, optionally under room temperature. The definitions and explanations provided for the diamines and dianhydrides, as well as any other features provided in the context of the present polyimide aerogel and its use, also apply to the method of the present invention. The skilled person in the field of polymer chemistry can routinely choose whether the combination of reagents in steps (i) to (iii) of the present method is accompanied by physical mixing, e.g. by agitating, shaking or stirring the mixture, or not. Mixing the diamine monomers and dianhydride monomers in step (i), the addition of acetic anhydride and triethylamine in step (ii) and/or the addition of a crosslinker in step (iii) can be done, e.g., under agitation or stirring.

In steps (i) and (ii) an aprotic solvent is used. The aprotic solvent or mixture is chosen by the skilled person such that upon addition of trimethylamine in step (ii) phase separation is induced, optionally a fast phase separation, e.g. within 3 to 20 minutes. Again, the skilled person can routinely choose the suitable aprotic solvent from the list of solvents disclosed herein which allows for fast phase separation to occur. Furthermore, the concentrations used and the optional ratio between two or more aprotic solvents can be routinely chosen by the person skilled in the art of chemistry and polymer chemistry, e.g. depending on the type and amount of diamine monomers and dianhydride monomers.

In step (ii) of the method described herein, the addition of acetic anhydride is used to remove water, and trimethylamine (TEA) is used to catalyze the imidization, and most importantly to induce the phase separation of polyimide from the solvent. TEA and acetic anhydride may be added together or separately in any order. Without wishing to be bound by theory, it is believed that inducing the phase separation with TEA leads to the formation of the polyimide spheres as described herein. Additionally, it is believed that a fast imidization reaction also promotes the formation of polyimide spheres. In this context, a fast imidization means that imidization is completed within 1 to 5 minutes. Optionally, in a method described herein, the mixing time in steps (ii) and optionally (iii) is smaller than the imidization time, e.g. such that the mixing time is stopped at a specific degree of imidization and the mixture is aged, or, e.g. transferred into a container, e.g. mold, before further imidization occurs (e.g. that would lead to precipitation). Exemplary mixing times (e.g. with stirring or agitating) in step (ii) for the imidization can range from 1 to 10 minutes, optionally 1 to 5 minutes. The progress of the polymerization reaction may be inspected by known means, e.g. by IR spectroscopy, NMR or rheology measurements.

Acetic anhydride can be, e.g., used stoichiometrically. Exemplary and non-limiting amounts of acetic anhydride include the molar ratios between acetic anhydride and dianhydride of 8:1 to 2:1, optionally 8:1 to 4:1.

Triethylamine can be, e.g., used stoichiometrically. Exemplary and non-limiting amounts of triethylamine include the molar ratios between triethylamine and acetic anhydride of 1:1 to 1:8, optionally 1:1 to 1:4.

The gelation can occur either after step (ii) or, if present, after optional step (iii). However, gelation may not be finished until after step (iv).

Crosslinking (step (iii)) can also be performed before TEA and acetic anhydride are added in step (ii) and the skilled person can routinely chose the suitable protocol, e.g. depending on the type of crosslinker that is used. For example, if TAB is used, TEA and acetic anhydride can be added following the addition of TAB, and vice-versa for crosslinkers such as BTC and TREN.

In an embodiment, the present method is one, wherein step (iii) is performed before step (ii).

Exemplary mixing times (e.g. with stirring or agitating) for crosslinking range from 1 to 15 or 1 to 10 minutes, optionally from 1 to 5 minutes.

Optionally, the crosslinker can be dissolved in an aprotic solvent, optionally the aprotic solvent of step (i), optionally in DMAc.

In an embodiment, the present method is one, wherein in step (v), the drying is performed under supercritical CO₂ (for example at 45 to 70° C. for, e.g., 5 to 10 hours at, e.g., about 120 bar), or under atmospheric pressure at temperatures between 1° and 200° C., optionally at temperatures between 2° and 100° C.

It was surprisingly found that the polyimide aerogels described herein and produced according to the method described herein display a low volumetric shrinkage when dried at comparatively high temperatures (i.e. in contrast to supercritical CO₂ drying). For example, low volumetric shrinkage of 10, 8 and 12% was observed, while the aerogels were dried at 200, 300 and 350° C., respectively, for 1 hour each. For comparison, prior art polyimide aerogels without the polyimide spheres described herein displayed a volumetric shrinkage of 95, 94 and 92% while kept under 200, 300 and 350° C., respectively, for 1 hour each. This means that the present method allows for facile and economical drying under atmospheric pressure without significant volumetric shrinkage.

In an embodiment, the present method is one, wherein the aprotic solvent in steps (i) and (ii) is a solvent selected from the group consisting of dimethylacetamide (DMAc), dimethylformamide (DMF), dimethyl sulfoxide (DMSO), mixtures thereof and mixtures of 30 v % or less, 25 v % or less, 20 v % or less, 15 v % or less, or 10 v % or less of N-methyl-2-pyrrolidone (NMP) with at least one of DMAc, DMF and/or DMSO (with v % meaning volume-%).

As used herein, the terms “30 v % or less, 25 v % or less, 20 v % or less, 15 v % or less, or 10 v % or less” include 30 v %, less than 30 v %, 1 to 30 v %; 25 v %, less than 25 v %, 1 to 25 v %, 20 v %, less than 20 v %, 1 to 20 v %, 15 v %, less than 15 v %, 1 to 15 v %, 10 v %, less than 10 v % and 1 to 10 v %, respectively.

In an embodiment, the present method is one, wherein the aprotic solvent in steps (i) and (ii) is DMAc, DMF, DMSO or a mixture of DMAc with DMF and/or DMSO.

In an embodiment, the present method is one, wherein the aprotic solvent in steps (i) and (ii) is DMAc or a mixture of DMAc with DMF and/or DMSO.

In an embodiment, the present method is one, wherein the aprotic solvent in steps (i) and (ii) is dimethylacetamide (DMAc) or a mixture of DMAc with a further aprotic solvent, optionally a solvent selected from the group consisting of N-methyl-2-pyrrolidone (NMP), dimethylformamide (DMF), and dimethyl sulfoxide (DMSO), optionally wherein for NMP this further solvent amounts to 30 v % or less, 25 v % or less, 20 v % or less, 15 v % or less, or 10 v % or less in the mixture.

Optionally, the aprotic solvent in steps (i) and (ii) is a mixture of DMAc with at least one further aprotic, optionally polar aprotic, solvent, optionally with a solvent selected from the group consisting of NMP, DMF and DMSO, optionally with at least 1 to 99 v % or at least 1, 5, 10, 15, 20, 25, 30, 35, 40, 45, 50, 55, 60, 65, 70, 75, 80, 85, 90, 95 or 99 v % of that further solvent and optionally with 30 v % or less, 25 v % or less, 20 v % or less, 15 v % or less or 10 v % or less of that further solvent if that further solvent is NMP.

Exemplary solvent mixtures include:
1 to 99 v % X/99 to 1 v % DMAc, optionally 90 to 10 v % X/10 to 90 v % DMAc, 40 to 60 v % X/60 to 40 v % DMAc, 50 v % X/50 v % DMAc, or 90 v % X/10 v % DMAc wherein X is selected from NMP, DMSO and DMF, wherein for NMP the maximum amount in the solvent mixture optionally is 30 v % or less, 25 v % or less, 20 v % or less, 15 v % or less, or 10 v % or less;
1 to 30 v % NMP/99 to 70 v % DMAc, optionally 1 to 25 v % NMP/99 to 75 v % DMAc, 1 to 20 v % NMP/99 to 80 v % DMAc; 1 to 15 v % NMP/99 to 85 v % DMAc, or 1 to 10 v % NMP/99 to 90 v % DMAc; and
1 to 30 v % NMP/99 to 70 v % DMF, 50 v % DMAc/50 v % DMF, 50 v % DMAc/50 v % DMSO, 50 v % DMF/50 v % DMSO (with v % meaning volume-%).

In an embodiment, the present method is one, wherein the concentration of the polyamic acid in steps (i) and/or (ii) is about 3 to 15 wt. %, optionally 5 to 15 wt. %, optionally about 6 to 10 wt. %.

In an embodiment, the present method is one, wherein in step (ii), the mixture is agitated (e.g. under stirring or agitating) for about 1 to 10 minutes, optionally about 1 to 5 minutes.

In an embodiment, the present method is one, wherein after step (iv) and before step (v) the solvent is exchanged with a mixture comprising one or a mixture of the polar aprotic solvents disclosed herein in the context of steps (i) and (ii), or with acetone in combination with heptane, hexane or one or more alcoholic solvents, optionally ethanol, methanol and/or isopropanol.

In a further aspect, the present invention is directed to a polyimide aerogel or its use, optionally the polyimide aerogel as defined herein, wherein the polyimide aerogel is obtained or obtainable by the method disclosed herein.

An exemplary non-limiting protocol for practicing the method of the present invention is provided in the following.

Biphenyl-3,3′,4,4′-tetracarboxylic dianhydride (BPDA), 4,4′-oxidianiline (ODA) and 2,2′-dimethylbenzidine (DMBZ) (the molar ratio between these two diamines can be in the range from, e.g., 10:0 to 0:10) are mixed with an exemplary molar ratio between dianhydride and diamine of n:(n+1) or (n+1):n in N,N-Dimethylacetamide (DMAc), where n can be, e.g., in the range of 5-40, the concentration of the amino-terminated or anhydride-terminated poly(amic acid) in the solution can be about, e.g., 5-15 wt. %. After, e.g., about 30 minutes polymerization, e.g., under room temperature, a mixture of acetic anhydride (AA) and trimethylamine (TEA) is slowly added to the poly(amic acid) solution and the whole mixture is stirred for 1 to 5 minutes. Optional amounts of TEA and AA include, e.g., the molar ratios between acetic anhydride and dianhydride of 8:1 to 2:1, the molar ratios between triethylamine and acetic anhydride of 1:1 to 1:8. Optionally, the cross-linker BTC or TREN or TAB, e.g. dissolved in DMAC, can be added into the system, and can be stirred, e.g. for 3 more minutes. Here, the addition of cross-linker is optional, which means that the cross-linker can be skipped. Additionally, the order of the addition of chemical imidizer and cross-linker can be switched, depending on the cross-linker used. For TAB, the chemical imidizers are added following the addition of TAB, and vice-versa for cross-linkers such as BTC and TREN. The mixture is transferred into (e.g. silicon or polypropylene) molds and the gelation occurs, e.g., within 5 to 30 minutes, depending on the number of repeat units, the solvent and the imidization process. Gels are aged, e.g. for 24 hours, e.g. at room temperature, until full gelation, and the solvent is exchanged, e.g. with 75/25, 25/75, and 0/100 DMAc/ethanol in 24 hours intervals. The gels are finally dried in a regular oven (e.g. at 10 to 200° C.) with or without vacuum, or by supercritical CO₂ drying. Finally, a porous polyimide aerogel with the aggregates of microspheres was obtained, where the microspheres consist of loose or dense polyimide nanofiber networks.

The following Figures and Examples serve to illustrate the invention and are not intended to limit the scope of the invention as described in the appended claims.

### FIGURES

FIG. 1A-D shows SEM images of polyimide aerogels as described herein: A and B are from ambient pressure drying; C and D are from supercritical CO₂ drying. Both are ethanol-based gels before drying.

FIG. 2 shows SEM images of polyimide aerogels from ambient pressure drying (corresponding to A (left) and B (right) in FIG. 1) after thermal aging treatment (350° C. and 1 hour).

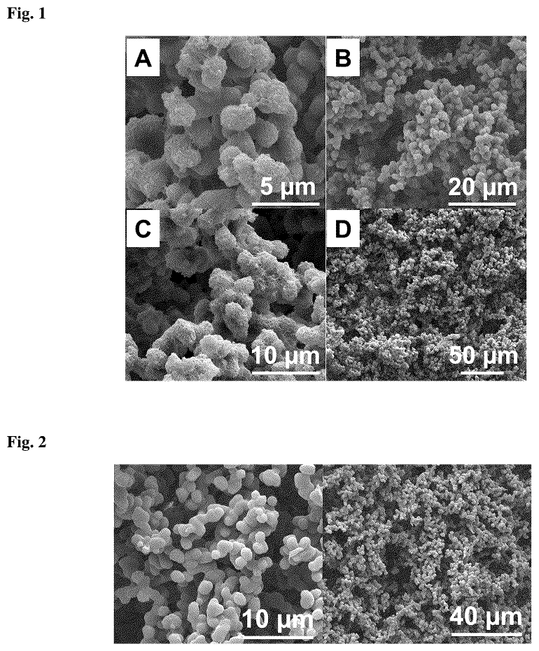

### EXAMPLES

### Example 1: Preparation of Polyimide Aerogels with Spherical Structure in the Polyimide Matrix Via Supercritical CO₂ Drying

2.0214 g biphenyl-3,3′,4,4′-tetracarboxylic dianhydride (BPDA), 0.7536 g 2,2′-dimethylbenzidine (DMBZ) and 0.7108 g 4,4′-oxidianiline (ODA) (the molar ratio between DMBZ and ODA is 5:5) was mixed with a molar ratio between dianhydride and diamine of respectively 30:31 in 40 ml dimethylacetamide (DMAc) solvent, the concentration of the polymer in the solution was about 7 wt. %, after 30 minutes polymerization under room temperature (S.T.P.) (step 1). The pre-mixed mixture of 5.20 mL acetic anhydride and 7.66 mL trimethylamine (TEA) was added slowly to the solution followed by stirring for 2 minutes (step 2). In the meantime, the 0.0405 g BTC was dissolved in 10 ml DMAc, the BTC solution was added in the polymer solution, and was stirred 2 more minutes (step 3). The sols were transferred into silicon molds and the gelation occurred within 10 minutes. Samples were aged 24 hours at room temperature (S.T.P.), and the solvent exchanged with 75/25, 25/75, and 0/100 DMAC/ethanol in 12 hours intervals (step 4). The wet gels were finally dried under supercritical CO₂ (step 5), at 50° C. and 120 bar for 7 hours.

Materials properties: bulk density 0.14 g/cm³, BET specific surface area 47.6 m²/g, thermal conductivity of 33.0 mW/(m*K), 7% and 20% volumetric shrinkage at 200° C. and 300° C. for 24 hours, respectively, the compression Young's Modulus is 0.75 MPa.

### Example 2: Alternative Preparation of Polyimide Aerogels with Spherical Structure in the Polyimide Matrix Via Ambient Pressure Drying

A procedure identical to that of example 1 was used, with the exception that during step 5, ambient pressure drying was chosen to replace the supercritical CO₂ drying for the drying out of ethanol from wet gels, which was carried out at ambient pressure, 75° C. for 5 hours.

Materials properties: bulk density 0.16 g/cm³, BET specific surface area 1.6 m²/g, thermal conductivity of 35.0 mW/(m*K), 8% and 18% volumetric shrinkage at 200° C. and 300° C. for 24 hours, respectively, the compression Young's Modulus is 0.78 MPa.

### Example 3: Alternative Preparation of Polyimide Aerogels with Spherical Structure in the Polyimide Matrix Via Supercritical CO₂ Drying

A procedure identical to that of example 1 was used, with the exception that during step 1, instead of pure DMAc solvent, the mixture of 20 v % NMP/80 v % DMAc were used for the synthesis of polymer.

Materials properties: bulk density 0.11 g/cm³, BET specific surface area 107.0 m²/g, thermal conductivity of 32.1 mW/(m*K), the compression Young's Modulus is 0.40 MPa, 30% and 35% volumetric shrinkage at 200° C. and 300° C. for 24 hours.

### Example 4: Alternative Preparation of Polyimide Aerogels with Spherical Structure in the Polyimide Matrix Via Supercritical CO₂ Drying

A procedure identical to that of example 1 was used, with the exception that during step 1, instead of the copolymerization of BPDA-ODA/DMBZ, only one diamine DMBZ was used for the synthesis of BPDA-DMBZ polymer.

Materials properties: bulk density 0.15 g/cm³, BET specific surface area 367.4 m²/g, thermal conductivity of 33.3 mW/(m*K), 15% and 25% volumetric shrinkage at 200° C. and 300° C. for 24 hours.

### Example 5: Alternative Preparation of Polyimide Aerogels with Spherical Structure in the Polyimide Matrix Via Ambient Pressure Drying

A procedure identical to that of example 2 was used, with the exception that during step 4, instead of ethanol for solvent exchange, the solvent hexane was used for solvent exchange, which was solvent exchanged with 75/25, 25/75, and 0/100 DMAC/hexane in 12 hours intervals (step 4), and ambient pressure drying afterwards.

Materials properties: bulk density 0.16 g/cm³, BET specific surface area 12.9 m²/g, thermal conductivity of 34.4 mW/(m*K), 10% and 20% volumetric shrinkage at 200° C. and 300° C. for 24 hours.

### Example 6: Alternative Preparation of Polyimide Aerogels with Spherical Structure in the Polyimide Matrix Via Ambient Pressure Drying

A procedure identical to that of example 2 was used, with the exception that during step 1, instead of using 50 mL DMAC for the synthesis, 800 mL DMAC was used to make a bigger gels (200 mm*200 mm*14 mm), in this case, the amount of all the chemicals used are scaled up, respectively.

Materials properties: bulk density 0.16 g/cm³, BET specific surface area 2.5 m²/g, thermal conductivity of 35.0 mW/(m*K), 8% and 18% volumetric shrinkage at 200° C. and 300° C. for 24 hours.

### Example 7: Alternative Preparation of Polyimide Aerogels with Spherical Structure in the Polyimide Matrix Via Ambient Pressure Drying

A procedure identical to that of example 2 was used, with the exception that during step 4, instead of ethanol for solvent exchange, the solvent heptane was used for solvent exchange, which was solvent exchanged with 75/25, 25/75, and 0/100 DMAC/heptane in 12 hours intervals (step 4), and ambient pressure drying afterwards.

Materials properties: bulk density 0.17 g/cm³, BET specific surface area 8.0 m²/g, thermal conductivity of 38.0 mW/(m*K), 10% and 18% volumetric shrinkage at 200° C. and 300° C. for 24 hours.

### Example 8: Alternative Preparation of Polyimide Aerogels with Spherical Structure in the Polyimide Matrix Via Supercritical CO₂ Drying

A procedure identical to that of example 1 was used, with the exception that during step 3, instead of the cross-linker of BTC, cross-linker TREN was used to make the gels.

Materials properties: bulk density 0.15 g/cm³, BET specific surface area 3.0 m²/g, thermal conductivity of 34.3 mW/(m*K), 7% and 19% volumetric shrinkage at 200° C. and 300° C. for 24 hours.

### Example 9: Alternative Preparation of Polyimide Aerogels with Spherical Structure in the Polyimide Matrix Via Supercritical CO₂ Drying

A procedure identical to that of example 1 was used, with the exception that during step 1, instead of pure DMAc solvent, the mixture of 30 v % NMP/70 v % DMAc were used for the synthesis of polymer.

Materials properties: bulk density 0.15 g/cm³, BET specific surface area 168.1 m²/g, thermal conductivity of 33.4 mW/(m*K), the compression Young's Modulus is 0.71 MPa, 30% and 40% volumetric shrinkage at 200° C. and 300° C. for 24 hours.

### Example 10: Alternative Preparation of Polyimide Aerogels with Spherical Structure in the Polyimide Matrix Via Supercritical CO₂ Drying

A procedure identical to that of example 1 was used, with the exception that during step 1, instead of pure DMAc solvent, the mixture of 10 v % NMP/90 v % DMAc were used for the synthesis of polymer.

Materials properties: bulk density 0.16 g/cm³, BET specific surface area 53.6 m²/g, thermal conductivity of 30.2 mW/(m*K), the compression Young's Modulus is 0.54 MPa, 25% and 36% volumetric shrinkage at 200° C. and 300° C. for 24 hours.

### Example 11: Alternative Preparation of Polyimide Aerogels with Spherical Structure in the Polyimide Matrix Via Supercritical CO₂ Drying

A procedure identical to that of example 1 was used, with the exception that during step 1, instead of pure DMAc solvent, pure DMF was used for the synthesis of polymer.

Materials properties: bulk density 0.12 g/cm³, BET specific surface area 3.5 m²/g, thermal conductivity of 34.2 mW/(m*K), the compression Young's Modulus is 1.05 MPa, 9% and 18% volumetric shrinkage at 200° C. and 300° C. for 24 hours.

### Example 12: Alternative Preparation of Polyimide Aerogels with Spherical Structure in the Polyimide Matrix Via Supercritical CO₂ Drying

A procedure identical to that of example 1 was used, with the exception that during step 1, instead of pure DMAc solvent, the mixture of 50 v % DMAc/50 v % DMSO were used for the synthesis of polymer.

Materials properties: bulk density 0.13 g/cm³, BET specific surface area 30.5 m²/g, thermal conductivity of 32.2 mW/(m*K), the compression Young's Modulus is 0.65 MPa, 15% and 22% volumetric shrinkage at 200° C. and 300° C. for 24 hours.

### Comparative Example 13: Preparation of Polyimide Aerogels with Conventional Mesoporous Structure in the Polyimide Matrix Via Supercritical CO₂ Drying

A procedure identical to that of example 1 was used, with the exception that during step 1, instead of pure DMAc solvent, pure NMP was used for the synthesis of polymer.

Materials properties: bulk density 0.07 g/cm³, BET specific surface area 433.9 m²/g, thermal conductivity of 24.7 mW/(m*K), the compression Young's Modulus is 7.00 MPa, 95% and 95% volumetric shrinkage at 200° C. and 300° C. for 24 hours.

1.-16. (canceled)

17. A thermal or electrical insulating material comprising a polyimide aerogel including polyimide spheres having a diameter of 250 nm to 20 μm, wherein the material is applied as thermal or electrical insulation.

18. The thermal or electrical insulating material according to claim 17, wherein
the polyimide spheres have a diameter of 1 μm to 10 μm;
the polyimide aerogel further comprises pores between polyimide spheres that range from 0.2 μm to 500 μm; or
a combination thereof.

19. The thermal or electrical insulating material according to claim 17, wherein the polyimide spheres are porous.

20. The thermal or electrical insulating material according to claim 19, wherein the polyimide spheres have pores with diameters between 1 nm to 100 nm.

21. The thermal or electrical insulating material according to claim 17, wherein the polyimide aerogel is halogen-free.

22. The thermal or electrical insulating material according to claim 17, wherein:
a. the polyimide aerogel has a thermal conductivity measured at 25° C. and 50% relative humidity of less than about 40 mW/(m*K);
b. the polyimide aerogel is hydrophobic;
c. the water contact angles on the polyimide aerogel are between 90° and 140°; or
d. a combination thereof.

23. The thermal or electrical insulating material according to claim 17, wherein the polyimide aerogel has:
a. a density of 0.06 to 0.2 g/cm³;
b. a porosity of 80 to 98%;
c. a Brunauer-Emmett-Teller specific surface area of 1 to 350 m²/g;
d. a Young's Modulus of 0.2 to 5 MPa; or
e. a combination thereof.

24. The thermal or electrical insulating material according to claim 17, wherein the polyimide aerogel is cross-linked.

25. The thermal or electrical insulating material according to claim 24, wherein the polyimide aerogel has a degree of crosslinking of 1 to 100%.

26. The thermal or electrical insulating material according to claim 17, wherein the polyimide aerogel comprises
(a) a diamine monomer selected from the group consisting of 4,4′-diaminodiphenyl ether (ODA); 2,2′-dimethylbenzidine (DMBZ); 9,9-bis(4-aminophenyl)fluorene (BAPF); 2-bis [4-(4-aminophenoxy) phenyl]propane (BAPP); p-phenylene diamine (PPDA); 4,4′-diaminodiphenylmethane (MDA); and combinations thereof;
(b) a dianhydride monomer selected from the group consisting of 3,3′,4,4′-biphenyltetracarboxylic dianhydride (BPDA); 4,4′-diphenyl ether dianhydride (ODPA); pyromellitic dianhydride (PMDA); 3,3′,4,4′-benzophenonetetracarboxylic dianhydride (BTDA); and a combination thereof;
(c) a crosslinker selected from the group consisting of 1,3,5-benzenetricarbonyl trichloride (BTC); tris(2-aminoethyl)amine (TREN); 1,3,5-tris(4-aminophenoxy)benzene (TAB); polymaleic anhydride (PMA); tris(4-aminophenyl amine) (TAPA); and triisocyanate, or
(d) a combination thereof.

27. The thermal or electrical insulating material according to claim 26, wherein the molar ratio of diamine monomer to dianhydride monomer within the polyimide is n:(n+1) or (n+1):n, wherein n is an integer ≥5.

28. An electronic device, robotic, aviation, astronautic, refrigeration, industrial installation, or pipeline comprising the thermal or electrical insulating material according to claim 17.

29. A low dielectric constant material comprising the polyimide aerogel according to claim 17.

30. A method for preparing the polyimide aerogel as described in claim 17, the method comprising the steps:
(i) providing a polyamic acid in an aprotic solvent comprising
(a) dimethylacetamide (DMAc), dimethylformamide (DMF), dimethyl sulfoxide (DMSO), or a mixture thereof; or
(b) a mixture of N-methyl-2-pyrrolidone (NMP) with DMAc, DMF, DMSO, or a combination thereof;
(ii) adding acetic anhydride and triethylamine to the polyamic acid of (i) to form a polyimide sol and to induce phase separation of the polyimide from the aprotic solvent; and
(v) drying the mixture.

31. The method according to claim 30, wherein:
(a) before or after step (ii) and before step (v), the method further comprises step (iii), adding a crosslinker before gelation of the polyimide sol, optionally BTC or TREN, to form a crosslinked polyimide sol;
(b) after step (iii) and before step (v), the method further comprises step (iv), aging the gelled polyimide sol of step (ii) and/or step (iii); or
(c) both (a) and (b).

32. The method according to claim 30, wherein in step (v), the drying is performed under supercritical CO₂ or under atmospheric pressure at temperatures between 1° and 200° C.

33. The method according to claim 30, wherein the aprotic solvent in steps (i) and (ii) is dimethylacetamide (DMAc) or a mixture of DMAc and a further aprotic solvent.

34. The method according to claim 33, wherein the further aprotic solvent is selected from the group consisting of N-methyl-2-pyrrolidone (NMP), dimethylformamide (DMF), and dimethyl sulfoxide (DMSO).

35. The method according to claim 30, wherein:
a. the concentration of the polyamic acid in steps (i) and/or (ii) is about 3 to 15 wt. %;
b. in step (ii), the mixture is agitated for about 1 to 10 minutes; or
c. both.

36. The method according to claim 31, wherein after step (iv) and before step (v) the solvent is exchanged with
(a) dimethylacetamide (DMAc), N-methyl-2-pyrrolidone (NMP), dimethylformamide (DMF), dimethyl sulfoxide (DMSO), or a mixture thereof, or
(b) acetone in combination with heptane, hexane, or one or more alcoholic solvents.

37. A polyimide aerogel produced according to the method according of claim 30.

38. An electronic component comprising the thermal or insulating material of claim 17 applied thereon.

39. A method of insulating an electrical component comprising the steps of:
providing an electrical component; and
applying a coating comprising the thermal or insulating material of claim 17.
